(19) United States
(12) Patent Application Publication
(10) Pub. No.: US 2013/0060856 A1
(43) Pub. Date: Mar. 7, 2013

(54) SOCIAL PROXY AND PROTOCOL GATEWAY

(71) Applicants: LANCE FRIED, Aventura, FL (US); JOSEPH KATZ, Atlanta, GA (US)

(72) Inventors: LANCE FRIED, Aventura, FL (US); JOSEPH KATZ, Atlanta, GA (US)

(21) Appl. No.: 13/604,929

(22) Filed: Sep. 6, 2012

Related U.S. Application Data
(60) Provisional application No. 61/532,011, filed on Sep. 7, 2011.

(51) Int. Cl. G06F 15/16

(52) U.S. Cl. 709/204

(57) ABSTRACT

A social proxy and protocol gateway for interfacing with a carrier network, a social listening device, a social network or proprietary social feedback apparatus, and a contact center and contact center database is disclosed. A data link is connected to a carrier network to receive, author tags, attributes, and routing information requests and other routing data. Additional data links are connected to a contact center database and a social network listening device or proprietary social feedback apparatus to obtain information used in determining routing and tagging instructions. A user interface is connected to the social proxy and protocol gateway to accept configurable conditions for determining routing instructions. A text conversion function and speech conversion function is disclosed for providing media conversion for the requirements of each target enterprise contact center.

### CROSS-REFERENCE TO RELATED APPLICATIONS

This application relates to and claims the benefit of U.S. Provisional Application No. 61/532011 filed Sep. 7, 2011 and entitled SOCIAL PROXY AND PROTOCOL GATEWAY, the entire content of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to telecommunications systems, and more particularly, to a social proxy and protocol gateway.

2. Related Art

Social networking services and blogging/micro-blogging services facilitate the sharing of comments, photographs, and other data amongst its users, who typically establish accounts and create profiles containing basic biographic data. The subject matter of comments posted on social networking sites oftentimes touch upon daily life experiences, including those relating to interactions with consumer-oriented businesses and products thereof. Accordingly, the observation of user-generated content on social networking sites provides companies an insight into their customers' minds, and is a valuable metric that goes beyond traditional surveying modalities.

Various systems for observing activity on social networks are known in the art, including Radian6, Lithium, Jive, Getsatisfaction.com, and so forth. Unfortunately, however, the consumer content does not easily relate back to the customer service inquiry or the interaction that was the genesis of the customer service experience.

Another problem that besets the enterprise in providing customer service over social media is that most do not have the apparatus to route the data from social streams as if it were inbound email, chat, phone calls or SMSs. Only proprietary software is available, and as a result, customer service over social media is effectively operating as an island in the enterprise contact center.

Accordingly, there is a need in the art to make such social media content actionable so that it can be placed in the normal flow of customer service center transactions. Furthermore, there is a need in the art for systems that contemplate the conversion of social media streams into a regular communication that the call center infrastructure is accustomed to handling. For instance, it would be advantageous to convert social media into an email and allow a standard email routing system to disposition it in a standard way.

### BRIEF SUMMARY

The present disclosure is directed to a social proxy and protocol gateway that connects social network interactions with customer service interactions, and determining the requisite actions with the cause and the customer or author of the social media. The social proxy and protocol gateway can be between the social networks and the enterprise customer service center and provide protocol conversion and routing such that social media streams become part of the everyday communication of a common enterprise, using common contact center apparatus. In accordance with one embodiment, there is a communications system for bridging social networks and customer contact centers. The system may include an incoming data access point connected to first data links to the social networks over carrier networks and receptive to social data and routing information requests thereof. There may also be an outgoing data access point connected to second data links to the customer contact centers. Furthermore, there may be an application server connected to the incoming data access point. The received social data and routing information requests may being segregated based at least on configurable routing instructions. The system may further include a component database. Additionally, there may be a plurality of modality-specific proxies for each segregation as defined by the configurable routing instructions. The proxies may be connected to the application server and to the outgoing data access point for communicating with the customer contact centers.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating one embodiment of a social proxy and protocol gateway in accordance with one embodiment of the present disclosure;

FIG. 2 is a flowchart showing the steps of receiving, labeling, and storing of incoming social data;

FIG. 3 is a flowchart showing the steps of telephony conversion in accordance with an embodiment of the present disclosure; and

FIGS. 4 is a flowchart showing telephony conversion according to one embodiment.

Common reference numerals are used throughout the drawings and the detailed description to indicate the same elements.

### DETAILED DESCRIPTION

The detailed description set forth below in connection with the appended drawings is intended as a description of the presently preferred embodiment of the present disclosure, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

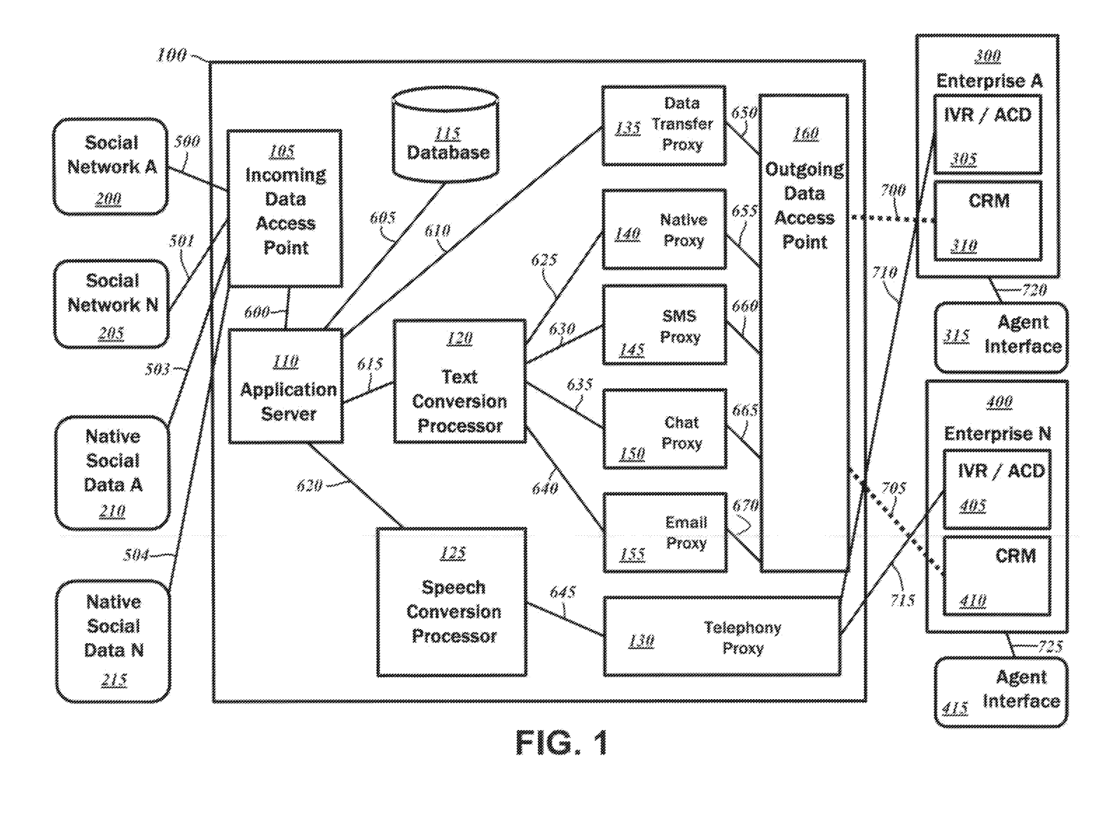

With reference to FIG. 1, a social proxy and protocol gateway 100 is illustrated, along with its interaction with a plurality of social networks, native social networks, and a plurality of enterprises. The social proxy and protocol gateway 100 includes an incoming data access point 105, an application server 110, and a database 115. Furthermore, there is a text conversion processor 120 and a speech conversion processor 125. The social proxy and protocol gateway also includes a data transfer proxy 136, a native proxy 140, SMS (Short Message Service) proxy 145, a chat proxy 150, an e-mail proxy 155, a telephony proxy 130, and an outgoing data access point 160. Further details regarding these components and their interconnections will be described more fully below.

The social proxy and protocol gateway 100, and specifically the incoming data access point 105 thereof, is connected to a social network A 200 and a social network N 205 over a communications channel 500 and a communications channel 501, respectively. In one preferred embodiment of the invention, such communications channels 500,501 may be the Internet or other Internet Protocol (IP)-based modality, and is understood to convey information over the HyperText Transfer Protocol (HTTP) or Secure Hypertext Transfer Protocol (HTTPS). In an alternate embodiment of the invention, such facilities may be proprietary in nature, bearing information conveyed over private networks.

Those having ordinary skill in the art will recognize various listening devices that produce HTTP/HTTPS streams of data that can be re-directed or listened to by a variety of devices. Such devices are typically agent consoles, in which agents are able to view social networking information that has been filtered social listening devices. These may be available from Salesforce.com and Attensity, for example. The incoming data access point 105 captures the stream of data from the social network A 200 and/or the social network N 205. It is to be understood that while the present disclosure only shows two social networks A, N 200, 205, there may be others connected to the social proxy and protocol gateway in accordance with different embodiments of the present disclosure. Thus, the social network N, in this context, is understood to refer to an indeterminate one.

The stream of data from the social networks A, N 200, 205 may have embedded information therein such as routing tags, thought leader tags, product tags, or other attributes that may be useful in processing social stream data for further routing or disposition. Here, the incoming data access point 105 is used to parse, inject, and format social data based on information supplied by templates that are pre-defined in the database 115. The application server 110 is used to decide what templates and what subsequent actions are taken depending on the incoming social streams.

Native social data A 210 and native social data N 215 also connect to the incoming data access point 105 over communications channels 503, 504, respectively. In one embodiment of the invention, such communications facilities may similarly be the Internet or any IP-based modality and will convey information over HTTP or HTTPS. In an alternate embodiment of the invention, such facilities may be proprietary in nature, bearing information conveyed over private networks. Native social data A 210 and native social data N 215 may convey social information that is embedded inside of proprietary software, such as smartphone devices, private enterprise web sites, or other proprietary devices. Such devices can be programmed to transmit social networking information, including consumer sentiment, that can be filtered and tagged by the native social data A 210 and the native social data N 215 entities. In this scenario, the incoming data access point 105 captures the stream of the native social data A 210 and the native social data N 215.

Such data may have embedded information therein such as routing tags, thought leader tags, product tags, or other attributes that may be useful in processing social stream data for further routing or disposition. The incoming data access point 105 is used to parse, inject, and format social data based on information supplied by templates that are pre-defined in the database 115. The application server 110 is used to decide what templates and what subsequent actions are taken depending on the incoming social streams.

The application server 110 is connected to the incoming data access point 105 over a communication channel 600. Such channel 600 may be an IP communication channel, or a proprietary channel Likewise, the application server 110 is connected to the database 115 over another communications channel 605. This communications channel may be implemented as a Java Database Connectivity (JDBC) access method, Structured Query Language (SQL) Query, Stored Procedure Call, or a variety of proprietary methods for database communications. The database 115 may be local or remote.

The application server 110 is also connected to the data transfer proxy 135 over a communication channel 610. The communication channel 610 can be an IP connection, HTTP, REST or other means to send signals and data. Additionally, the application server 110 is connected to the text conversion processor 120 over a communication channel 615. Such a communication channel can be an IP connection, HTTP, REST or other means to send signals and data. The application server 110 is also connected to the speech conversion processor 125 over a communication channel 620. Likewise, the communication channel 620 can be an IP connection, HTTP, REST or other means to send signals and data.

The database 115 stores a variety of information dealing with text or speech conversion protocols, social attribute tag data, routing and destination data, timing threshold information, and other attributes that aid in the processing and disposition of social networking media streams. Templates are stored in the database 115 that define pre-determine routines for processing social media streams. User interfaces to the database 115 can be implemented as web pages, and those having ordinary skill in the art will recognize the various ways in which the storage of user-typed data in templates inside of a database can be achieved. The templates can be created by a provider of the social proxy and protocol gateway 100; or, with the proper security, can be created by users of an enterprise A 300 or of an enterprise N 400. The application server 110 can be used to govern the communications with the database 115 in the case of its access being allowed for users of the respective enterprises A and N, 300, 400.

The text conversion processor 120 receives incoming social media stream information and re-formats the same into a standard text payload. The re-formatting may be for e-mail, and those having ordinary skill in the art will recognize the form of e-mail headers and addressing. Assuming the routing and destination data in a stored template in the database 115 calls for a social stream to be converted into an e-mail, the text conversion processor will parse the data, create a MIME header, and embed all of the requisite addressing information into the item. In a preferred embodiment of the invention, the “sender” address may be spoofed in such a way as to use the handle or pseudo-name of the social poster as the originating email address.

Likewise, if a response back to the poster is required, the text conversion processor 120 may be used in reverse, so as to dis-assemble an email and re-construct a social stream in the same format as the original, incoming social media stream from the social network A 200 or the social network N 205. It will be appreciated that the text conversion processor 120 can convert social media streams into any text-based format. For example, in the case of a social-to-chat conversion, the social media stream can be parsed much like an email, but instead of a MIME address conversion, the text conversion processor can instead put the media into the form of a chat request. Such a chat request can be directed to an enterprise chat server using Short Message Peer-to-Peer (SMPP) or other common protocols. Likewise, an SMS conversion can spoof destination addresses with an SMS short code and routing information that is suitable for reading by an SMS gateway.

The speech conversion processor 125 reformats the incoming social media stream information into a standard speech payload. According to one embodiment, common text-to-speech conversion utilities such as those from Nuance communications can be utilized. The speech conversion processor 125 may be capable of reading text and synthesizing a spoken word equivalent.

In an alternate embodiment, the routing and destination data in a stored template in the database 115 may call for a social stream to be converted into speech. Here, the speech conversion processor 125 will parse the data, create a Session Initiation Protocol (SIP) header, and embed all of the requisite addressing information into the item. In a preferred embodiment of the invention, the “sender” address may be spoofed in such a way as to speak the handle or pseudo-name of the social poster as the “caller.” Likewise, if a response back to the poster is required, the speech conversion processor 125 may be used in reverse, so as to reconstruct the spoken word of an enterprise agent into a social stream in the same format as the original, incoming social media stream from the social network A 200 or the Social Network N 205.

The speech conversion processor 125 is connected to the telephony proxy 130 over a communications channel 165. In a preferred embodiment of the invention, such communication channel 165 may be in the form of a SIP-based communication, using a Media Resource Control Protocol (MRCP) to control the Text-To-Speech or Speech-To-Text conversion Likewise, a Real-Time Transport (RTP) communication channel and a separate SIP channel for control may be used for the speech conversion processor 125 to communicate to the telephony proxy 130.

The telephony proxy 130 is used to take the SIP Header information, the content from the social media stream, and convey the same via phone call to the enterprise A 300 or the Enterprise N 400 systems over communication facilities 710 and 715, respectively. Those having ordinary skill in the art will recognized that the telephony proxy 130 can be implemented with commonly available tools such as FreeSwitch or the SOPHIA SIP stack, along with hardware from Diaglogic Corporation or Sangoma corporation. The aforementioned communications facilities may be a Public Switched Telephone Network (PSTN) or Voice over Internet Protocol (VoIP) facilities. This is readily configured, as the telephony proxy can be equipped with PSTN/VoIP conversion apparatus to serve either type of network interface.

The enterprise A 300 and the enterprise N 400 each have an interactive voice response (IVR) system and/or an automatic call distribution (ACD) system 305, 405, respectively. The telephone calls made by the telephony proxy 130 are processed by the telephone answering and routing apparatus deployed by that particular enterprise. The templates stored in the database 115 can be used to navigate the telephony-based menu system in order to dispose the calls to an appropriate agent. Once routed, the IVR/ACD 305, 405 will send the calls to respective agent interfaces 315, 415 over communications channels 720, 725. Such communications channels will be dependent on the IVR or ACD deployed by the enterprise.

Contemporaneously to the calls being placed by the telephony proxy 130, the outgoing data access point 160 may convey coordinating signals over communication channels 700 or 705 to a customer relationship management (CRM) 310, 410, respectively, also respectively on behalf of the Enterprise A 300 and the Enterprise N 400. Such a communication is known using commonly available protocols from vendors such as AVAYA or Cisco, for example. In an alternate embodiment of the invention, such communications links may also be achieved without CTI per se, but rather by communicating directly to a desktop software in an agent interface 315, 415.

The outgoing data access point 160 derives its chief communications payload, media and routing information from the data transfer proxy 135, which is controlled by the application server 110. The application server 110 can use the template data stored in the database 115 to instruct the data transfer proxy 135 how to assemble coordinating routing and destination data, along with any appropriate tag or attribute data, such that it can assemble information in the appropriate target CTI or proprietary format for any given enterprise.

The native proxy 140, the SMS proxy 145, the chat proxy 150, and the e-mail proxy 155 are all similarly situated as the data transfer proxy 135 in their relation to the outgoing data access point 160. In some cases, all of the relevant routing, attribute, payload and destination information may be embedded in the media as with an email. Emails, for example, have origination, destination, subject and body. Tags and other relevant data may be stored in the subject line for downstream processing.

Likewise, tags and other relevant data may be inserted into the body of the email. Such data, including the origination, destination and other attributes may be enough to process the information in an Enterprise email routing and distribution system. Such systems are available from Oracle and Avaya, for example. In the case of a communication not having all of the relevant routing, destination, or other attributes available in the payload or header of the communication, the data transfer proxy 135 can be of particular utility in contemporaneously transmitting such data out-of-band while the message payload is delivered over a commonly available medium.

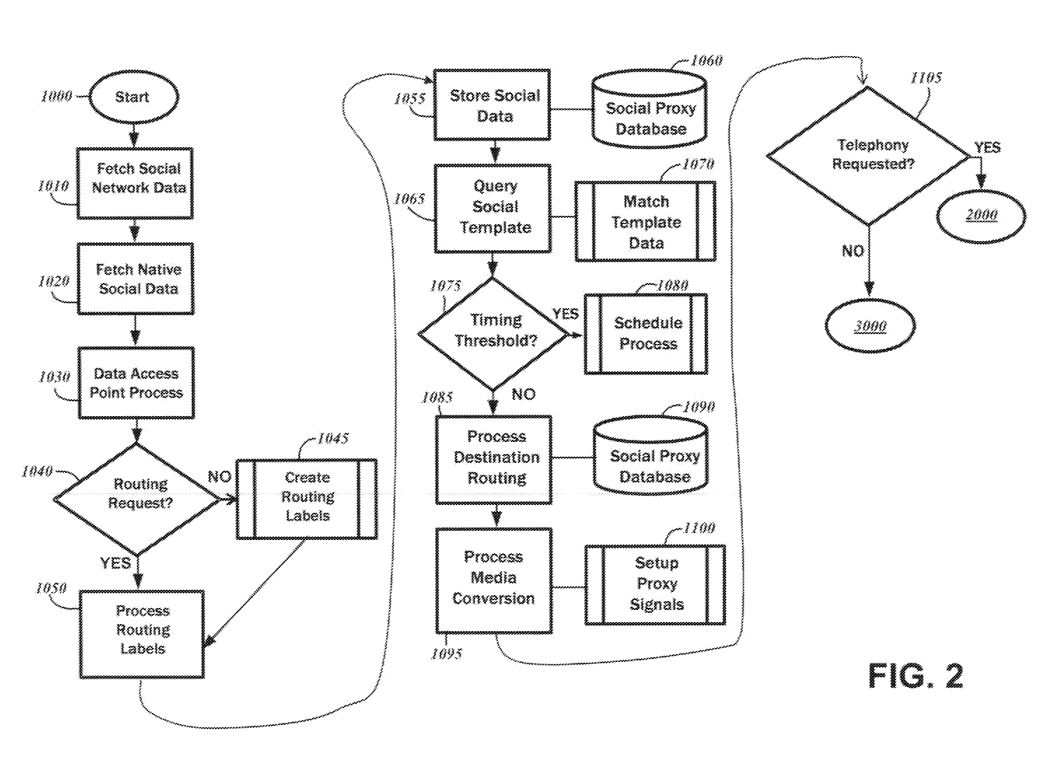

One embodiment of the present disclosure contemplates a method that includes the receipt, labeling, and storing of incoming social data, best illustrated in the flowchart of FIG. 2. The method has a start 1000 and is understood that social mentions are created on a formal social network, blog site, enterprise customer service portal, or on a proprietary smartphone or other proprietary application in the form of a private or native sentiment broadcast or mention. Next, at step 1010, the social proxy and protocol gateway 100 fetches such social network data. This data may be raw, unfiltered data, or it may be pre-processed by a listening device, such as those available from Attensity or Salesforce.com. Likewise, such social data may be pre-processed by a decisioining engine, or natural language processing engine. Next, in a step 1020, native social data, including proprietary or standard sentiment broadcast data is fetched.

The social proxy and protocol gateway 100 then utilizes the data access point 105 to parse the text of the social data in order to identify any routing, origination, or tag information, or other intelligent attributes that may be used in its disposition per a step 1030. Thereafter, the social proxy and protocol gateway 100 determines if a predetermined routing request has been logged and identified for the type of social media fetched in a decision branch 1040. This data is stored in a template in the database 115. If there is no routing data, the method proceeds to a step 1045 where default routing rules are used based on available data in the social media. If routing information is available that matches with the pre-defined templates, the process proceeds to a step 1050 where the appropriate routing labels and other data are tagged to the social media stream to determine which type of communication the social data will be converted to downstream.

At a step 1055, the social proxy and protocol gateway 100 stores the social media data in the database 115 per step 1060. Such data may be used as an archive or for purposes of store-and-forward for redundancy and recovery. Per step 1065, the social proxy and protocol gateway 100 further queries the pre-defined social template and loads that data into memory. At a step 1070, the application server 110 matches the stored template data with the attributes of the social media.

At a decision branch 1075, the timing threshold attribute is inspected to ascertain the importance or priority of the social media based on attributes stored in the social media template. If timing thresholds are defined, the social media is scheduled for action in step 1080. This may be as simple as a one hour or two-hour delay or a delay for only minutes depending on the preferences of the enterprise the social proxy and protocol gateway 100 is serving.

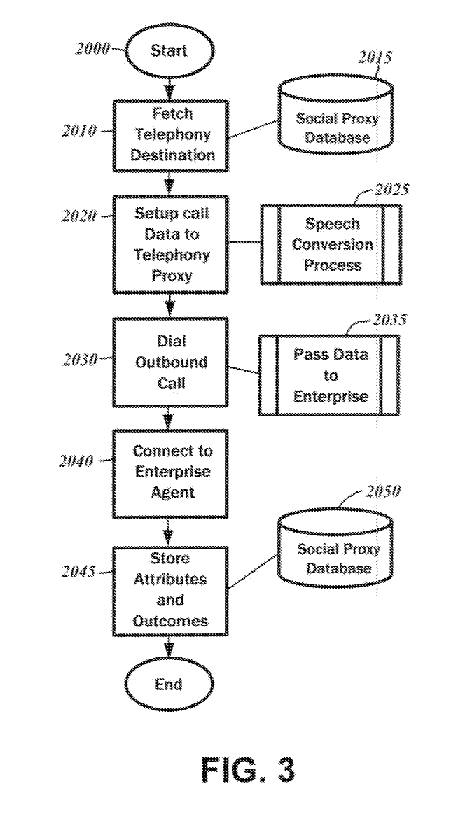

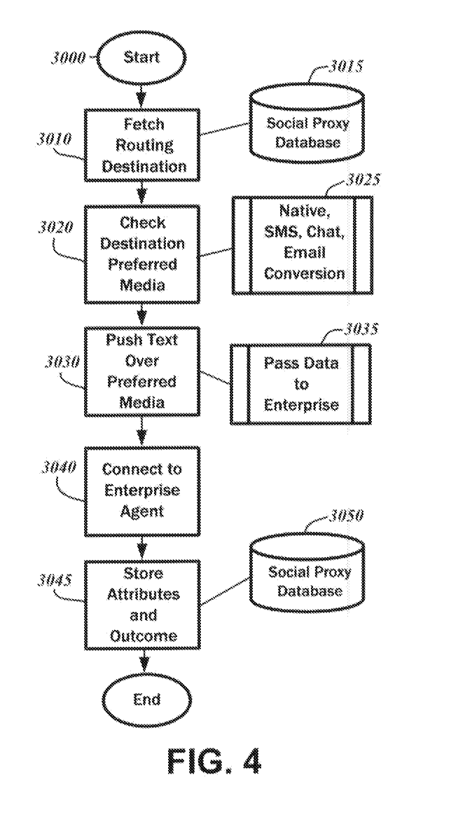

At a step 1085, the social proxy and protocol gateway processes all of the relevant attributes required for destination routing of the social media. The database 115 may be queried per 1095 for default routing information not stored in the template. At step 1095, the application server determines the type of media conversion requested in the template and loads the appropriate parsing, addressing, and content data based on pre-defined protocols per 1100. The application server hands this data off to the text conversion processor 120 and the speech conversion processor 125 as appropriate, depending on the medium required by the enterprise. At a decision branch 1105 the social proxy and protocol gateway 100 determines if telephony treatment is required. If telephony treatment is required the process continues at a step 2000 as further described below with reference to FIG. 3. Alternatively, if no telephony treatment is required, the process continues at step 3000 as described below with reference to FIG. 4.

With reference to FIG. 3, a telephony conversion routine begins with a step 2000 after the social proxy and protocol gateway 100 has determined telephony treatment is required to dispose the social media stream. The social proxy and protocol gateway 100 fetches the telephony destination information required to make a phone call to the target enterprise in a step 2010. The database 115 is queried per 2015 for default telephony routing information. Next, in a step 2020, the social proxy and protocol gateway begins to set up a telephone call with all of the relevant origination information [quasi-ANI] and destination information [quasi-DNIS]. At step 2025, the system converts text to speech to prepare the content of the telephony call.

The social proxy and protocol gateway 100 initiates an outbound call to the enterprise IVR/ACD 305, 405 in accordance with a step 2030. Contemporaneously, any data that is relevant to the call may be passed to the enterprise over a data link at step 2035. At step 2040, a connection is made to the enterprise agent, based on the native routing capabilities of the IVR/ACD 304, 405 of that enterprise. The agent will hear the transcribed social media in the form of the spoken word. Here the agent will take appropriate action such as looking up the identity of the originator of the social network data in the CRM database, adding comments, or making an outbound communication over a customer-preferred communication channel. Per step 2050, the information entered by the agent in response to, or in recognition of the social media stream, will be stored in the social proxy and protocol gateway 100, and in particular, its database 115. Alternately, such data may be stored in an enterprise database. It is expressly contemplated that the data may be stored in both database 115 and the enterprise database.

Various embodiments of the present disclosure also contemplate a text conversion routine, the details of which are shown in the flowchart of FIG. 4. The process begins at 3000, after the social proxy and protocol gateway 100 has determined that a text conversion treatment is necessary to dispose the social media stream. In a step 3010, the social proxy and protocol gateway 100 fetches the social media destination information required to send native data, or a chat, or an email, or an SMS to the target enterprise. The database 115 may be queried per 3015 for default media routing information. At step 3020, the social proxy and protocol gateway 100 begins to set up a native send, or a chat, or an SMS, or an email, with all of the relevant origination information [quasi-ANI] and destination information [quasi-DNIS]. In a step 3025, the system converts the social media stream into the appropriate text format for a native send, or a chat, or an SMS, or an email.

The social proxy and protocol gateway 100 pushes the preferred communication (i.e. native send, or a chat, or an SMS, or an email) to the enterprise IVR/ACD 304, 405. Contemporaneously, any data that is relevant to the call may be passed to the enterprise over a data link in a step 3035. Then, in a step 3040, a connection is made to the enterprise agent, based on the native routing capabilities of the IVR/ACD of that enterprise. The agent will see the transcribed social media in the form of a native send, or a chat, or an SMS, or an email, as stipulated by the template taken from the social proxy and protocol gateway database 115. Here the agent will take appropriate action such as looking up the person in the CRM database, adding comments, or making an outbound communication over a customer-preferred communication channel. Next, in a step 3050, the information entered by the agent in response to, or in recognition of the social media stream, will be stored in the social proxy and protocol gateway database 115. Alternately, such data may be stored in the enterprise database, or in both the social proxy and protocol gateway database 115 and the enterprise database.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A communications system for bridging social networks and customer contact centers, the system comprising:
an incoming data access point connected to first data links to the social networks over carrier networks and receptive to social data and routing information requests thereof;
an outgoing data access point connected to second data links to the customer contact centers;
an application server connected to the incoming data access point, the received social data and routing information requests being segregated based at least on configurable routing instructions;
a component database; and
a plurality of modality-specific proxies for each segregation as defined by the configurable routing instructions, the proxies being connected to the application server and to the outgoing data access point for communicating with the customer contact centers.

2. The system of claim 1, wherein the application server receives a routing request from the carrier network over one of the first data links.

3. The system of claim 2, wherein the application server generates a routing label based upon a query of the component database with the routing request.

4. The system of claim 3, wherein a configurable time threshold defines routines to be performed in querying the component database.

5. The system of claim 4, wherein a default destination label is set upon one of the expiration of the time threshold and a non-response from the component database.

6. The system of claim 1, wherein a routing label to the carrier network is delivered over the first data link.

7. The system of claim 6, wherein the routing label delivered to the carrier network over the first data link is in a format selected from a group consisting of: a 10-digit phone number, a Session Initiation Protocol (SIP) address, a Uniform Resource Location (URL), and an Internet Protocol (IP) address.

8. The system of claim 1, wherein the routing request data is used obtain data over one of the second data links from one or more contact center databases.

9. The system of claim 8, wherein the data from one or more contact center databases is obtained over the second data link at user-defined intervals defined with routing request information previously received over the first data link.

10. The system of claim 8, wherein the data obtained from one or more contact center databases is formatted using user-configured templates.

11. The system of claim 1, wherein the routing request data is used to obtain data over a third data link from one or more social listening devices.

12. The system of claim 11, wherein the application server formats data obtained from the one or more social listening devices with user-configured templates.

13. The system of claim 11, wherein the application server, using user-defined parameters, manipulates the formatted social listening device data.

14. The system of claim 11, wherein the application server transforms qualitative data obtained over the third data link into quantitative data for the purpose of determining a routing label.

15. The system of claim 11, wherein the data is obtained from the one or more social listening devices over the third data link at user-defined intervals using routing request information previously received over the first data link.

16. The system of claim 11, wherein the application server determines a routing label with data obtained over the second and third data links when a routing request has not been received using user-defined intervals.

17. The system of claim 1, wherein one of the proxies is an email gateway connected over the second data link to one or more contact center databases and media channel interfaces.

18. The system of claim 17, wherein:
the routing request data is used to obtain data over a third data link from one or more social listening devices;
the application server formats data obtained from the one or more social listening devices with user-configured templates; and
the email gateway sends the formatted social listening data over the second data link to one or more contact center databases.

19. The system of claim 1, wherein one of the proxies is a chat gateway connected over the second data link to one or more contact center databases and media channel interfaces.

20. The system of claim 1, wherein one of the proxies is a Short Message Service (SMS) server connected over the second data link to one or more contact center databases and media channel interfaces.

21. The system of claim 1, wherein one of the proxies is a speech conversion server connected over the second data link to one or more contact center databases and media channel interfaces.

22. The system of claim 21, wherein the speech conversion server transforms audio obtained over the first data link into text for storage in the component database.

23. The system of claim 1, wherein the application server transforms qualitative data obtained over the second data link into quantitative data for deriving a routing label.

24. The system of claim 1, wherein a routing request from a device is accepted over the first data link that does not present an established carrier access code subject to the device passing an authentication challenge generated by the application server.

25. The system of claim 1, wherein the a destination label is delivered to one or more carrier networks and devices over the first data link when a routing request has not been received subject to a user-configurable condition being reached.
